(19) United States
(12) Patent Application Publication
(10) Pub. No.: US 2008/0145675 A1
(43) Pub. Date: Jun. 19, 2008

(54) Anti-Static Surface Treatment

(75) Inventors: Jurgen Panhans, Forchheim (DE); Michael Bauer, Forchheim (DE)

Correspondence Address: COLLARD & ROE, P.C., 1077 NORTHERN BOULEVARD, ROSLYN, NY, 11576, US

(73) Assignee: Huhtamaki Forchheim Zweigniederlassung Der Huhtamaki Deutschlan GmbH & Co Kg

(21) Appl. No.: 11/794,644

(22) PCT Filed: Jan. 10, 2006
(86) PCT No.: PCT/EP2006/050139

§ 371 Date: Jul. 2, 2007

(30) Foreign Application Priority Data
Jan. 12, 2005 (DE) 102005001616.2

(51) Int. Cl. B32B 33/00

(52) U.S. Cl. 428/447

(57) ABSTRACT

Anti-static surface treatment for plastic film or similar material, where an additive that produces the anti-static properties is included in the surface.

The invention relates to anti-static surface treatment for plastic film or similar material.

Although many different forms of surface treatment have been disclosed, most of them do not have anti-static properties. When the forms of surface treatment disclosed in the past do have anti-static properties, they are obtained solely at the expense of other disadvantageous properties.

The purpose of the invention is to propose a form of anti-static surface treatment that has these properties without adversely affecting other surface properties.

In the solution to this problem proposed by the invention, an additive that produces the anti-static properties is included in the surface.

The anti-static properties are produced by this additive without adversely affecting the other properties of the plastic film.

It has also proved to be extremely advantageous if the surface is given non-stick treatment.

It is very advantageous in this context if the surface is provided with a siliconised finish.

Siliconised surfaces have a particularly strong tendency to develop undesirable static charges, in view of which the combination of a siliconised surface and anti-static treatment is very advantageous.

In another very advantageous further development of the invention, the siliconised finish is provided with the additive.

The siliconised finish becomes anti-static due to the treatment of the siliconised finish with the additive.

In accordance with a very advantageous further development of the invention, the siliconised finish can be formed by a solvent-based silicone.

It is also extremely advantageous if the siliconised finish is formed by a solvent-free silicone.

It is also very advantageous if the siliconised finish is formed by a UV-crosslinkable or UV-curable silicone.

Depending on the application, solvent-based, solvent-free and UV-crosslinkable or UV-curable silicones have particular advantages.

In another extremely advantageous further development of the invention, the additive is embedded physically in the surface, a surface layer or a surface coating of the plastic film.

As a result of this, the additive is embedded in the molecules, but migration processes of the additive, for example to the surface, can take place.

In another very advantageous further development of the invention, the additive is incorporated in the surface, a surface layer or a surface coating chemically.

The additive is incorporated firmly in the molecular structure as a result.

It has also proved to be very advantageous if carbon—graphite in particular—is provided as the additive.

Carbon has good electric properties and already prevents static charging when it is present in small quantities.

It is also very advantageous if polyethylene glycol or a similar substance is provided as the additive.

Polyethylene glycol generally does not crosslink with silicones and is therefore embedded in the molecular structure physically as a rule. This also makes it possible for the polyethylene glycol to migrate to the surface, in order to influence the anti-static properties.

In accordance with another further development of the invention, it is also very advantageous if acrylate and/or methacrylate groups are added to the polyethylene glycol.

This makes it possible to bond polyethylene glycol provided with these groups to the molecules of the surface chemically.

In another extremely advantageous further development of the invention, a material that conducts electricity is provided as the additive.

It has proved to be very advantageous in this context if a metal such as aluminium is provided as the additive.

It is possible as a result not only to produce the anti-static effect but also to give the plastic film relevant electricity conductivity properties.

In another very advantageous further development of the invention, a methylene diamino methyl ether polycondensate or a similar substance is provided as the additive.

Methylene diamino methyl ether polycondensate has proved to be a very good substance for improving the anti-static properties of the surface of the plastic film.

It has also proved to be extremely advantageous if a matting agent for plastic films is included as the additive.

Matting agents are easy and inexpensive to obtain on the market and produce very good anti-static properties when they are incorporated.

It is also very advantageous if the additive is distributed finely.

The properties of granulated additives and/or solid additives in particular are very consistent when they are distributed finely in the plastic and/or the surface layer.

It has also proved to be extremely advantageous if the additive is provided in the form of flakes etc.

The anti-static properties can be set particularly effectively in this case.

In accordance with another further development of the invention, it is very advantageous if the additive is included in the plastic and/or the surface coating in a concentration of between 0.1 and 10 percent, preferably between 0.1 and 3%.

Small concentrations of an additive are already sufficient to produce the required anti-static properties.

One embodiment of the invention is outlined below.

A solvent-based silicone finish is applied to one side of a plastic film. Such films have a very strong tendency to develop static charges, which is particularly unwelcome when such films are being handled in packaging processes and which should be avoided.

Methylene diamino methyl ether polycondensate is therefore included in the silicone as an additive and makes sure that static charging is reduced to an extremely large extent.

Measurements have revealed that a siliconised polypropylene film develops a charge of up to 30 kV/m. This charge decreases to about 29.2 kV/m over 60 seconds. If the same polypropylene film is treated with silicone that has been provided with the additive, the maximum charge is on the one hand drastically lower while it also decreases even more quickly. Measurements taken on this film have shown that this film only develops a maximum charge of 4 kV/m on the side provided with the silicone finish. The charge then decreases to 3 kV/m within 60 seconds. A further measurement on the back of the same film led in turn to higher readings. The maximum charge on the back amounted to 19 kV/m, which decreases faster than the conventional film even so: to 16.5 kV/m within 60 seconds.

The silicone finish provided with the additive not only develops a far lower charge itself but also influences the back of the plastic film in such a way that the static charge is reduced there too.

Further investigations have demonstrated that neither the release force nor the reduction in the adhesive force of a pressure sensitive adhesive covered with the silicone finish in which the additive has been included is changed by comparison with conventional siliconisation.

It is conceivable that solvent-free silicone is used for siliconisation purposes too.

The anti-static treatment in accordance with the invention can be applied to any plastic film substrates.

It is also conceivable that polyethylene glycol, polyethylene glycol provided with acrylate and/or methacrylate groups, any electrically conductive material, carbon or aluminium particles can be used as an additive either alone or in combination with the other substances instead of the additive methylene diamino methyl ether polycondensate.

When solids are used as the additive, it is advisable to opt for a prepared paste that is incorporated in the surface material of the plastic film and is distributed there as homogeneously as possible.

1. Anti-static surface treatment for plastic film or similar material, wherein an additive that produces the anti-static properties is included in the surface.

2. Surface treatment in accordance with claim 1, wherein the surface is given non-stick treatment.

3. Surface treatment in accordance with claim 2, wherein the surface is provided with a siliconised finish.

4. Surface treatment in accordance with claim 3, wherein the siliconised finish is provided with the additive.

5. Surface treatment in accordance with claim 3, wherein the siliconised finish is formed by a solvent-based silicone.

6. Surface treatment in accordance with claim 3, wherein the siliconised finish is formed by a solvent-free silicone.

7. Surface treatment in accordance with claim 3, wherein the siliconised finish is formed by a UV-crosslinkable or UV-curable silicone.

8. Surface treatment according to claim 1, wherein the additive is embedded physically in the surface, a surface layer or a surface coating of the plastic film.

9. Surface treatment according to claim 1, wherein the additive is incorporated in the surface, a surface layer or a surface coating chemically.

10. Surface treatment according to claim 1, wherein carbon—graphite in particular—is provided as the additive.

11. Surface treatment according to claim 1, wherein polyethylene glycol or a similar substance is provided as the additive.

12. Surface treatment according to claim 11, wherein acrylate and/or methacrylate groups are added to the polyethylene glycol.

13. Surface treatment according to claim 1, wherein a material that conducts electricity is provided as the additive.

14. Surface treatment according to claim 13, wherein a metal such as aluminum is provided as the additive.

15. Surface treatment according to claim 1, wherein a methylene diamino methyl ether polycondensate or a similar substance is provided as the additive.

16. Surface treatment according to claim 1, wherein a matting agent for plastic films is included as the additive.

17. Surface treatment according to claim 1, wherein the additive is distributed finely.

18. Surface treatment according to claim 1, wherein the additive is provided in the form of flakes etc.

19. Surface treatment according to claim 1, wherein the additive is included in the plastic and/or the surface coating in a concentration of between 0.1 and 10 percent, preferably between 0.1 and 3%.
